(19) United States
(12) Patent Application Publication
(10) Pub. No.: US 2026/0186351 A1
(43) Pub. Date: Jul. 2, 2026

(54) DISPLAY APPARATUS

(71) Applicant: LG Display Co., Ltd., Seoul (KR)

(72) Inventors: Cheol Woo PARK, Paju-si (KR); Dae Hyun NAM, Paju-si (KR); Chan Soo PARK, Paju-si (KR); Gyu Sik WON, Paju-si (KR)

(73) Assignee: LG Display Co., Ltd., Seoul (KR)

(21) Appl. No.: 19/330,135

(22) Filed: Sep. 16, 2025

(30) Foreign Application Priority Data
Dec. 31, 2024 (KR) 10-2024-0202754

(51) Int. Cl. G02F 1/1343; G02F 1/133; G02F 1/1362; G02F 1/1368

(52) U.S. Cl. CPC G02F 1/134309; G02F 1/13312; G02F 1/136286; G02F 1/1368

(57) ABSTRACT

Disclosed is a display apparatus configured to improve the transmittance of a sensing area in a liquid crystal display panel, thereby enhancing the recognition rate of an optical element. The display apparatus includes a liquid crystal display panel including an active area in which gate lines and data lines are alternately arranged to define a plurality of subpixel areas, and a bezel area adjacent to the active area. The active area includes a sensing area through which external light is received. An optical element is provided to detect external light or capture an image. Each subpixel area includes a thin film transistor and a pixel electrode. The thin film transistor includes a gate electrode, a semiconductor pattern, a drain electrode, a source electrode, a gate insulating film, and an element protection film. In the sensing area, the gate insulating film and the element protection film are not disposed below the pixel electrode to increase light transmittance.

### CROSS-REFERENCE TO RELATED APPLICATION(S)

This application claims the benefit of Korean Patent Application No. 10-2024-0202754, filed on Dec. 31, 2024, which is hereby incorporated by reference as if fully set forth herein.

### BACKGROUND

### Technical Field

The present disclosure relates to a display apparatus capable of improving the transmittance of a sensing area of a liquid crystal display panel to increase the recognition rate of an optical element.

### Description of the Related Art

In general, a display apparatus provides an image to a user. For example, the display apparatus may include a backlight unit and a liquid crystal display panel that generates an image using light supplied from the backlight unit. The backlight unit may include a light source element located on one side surface of a light guide plate. The liquid crystal display panel may be located on the light guide plate.

The display apparatus may include an optical element for detecting external light or capturing an image. The optical element may overlap a portion of the liquid crystal display panel. The liquid crystal display panel may include an active area for displaying an image and a bezel area disposed around the active area to surround the active area. The active area may include a sensing area for providing external light to the optical element.

However, a polarizer, a liquid crystal layer, a color filter layer, etc., are present in the sensing area of the liquid crystal display panel. Since the polarizer, the liquid crystal layer, the color filter layer, etc., are present in the sensing area, the transmittance of light incident on the optical element is reduced. Therefore, the recognition rate of the optical element may be reduced.

### BRIEF SUMMARY

The disclosed display apparatus achieves improved light transmittance in a designated sensing area of the liquid crystal display panel through specific structural modifications. In particular, the gate insulating film and the element protection film are not formed beneath the pixel electrodes within the sensing area. This configuration leads to an increase in transmittance (e.g., measured at approximately 5.85 percent), which enhances the performance of an optical element such as a camera or infrared sensor located behind the display.

Additional structural differences are applied to the pixel electrode within the sensing area. In contrast to the electrode structure in the main image-rendering area, which includes multiple bent fingers and a connector that electrically joins their ends, the electrode in the sensing area is simplified. It consists of fewer fingers, lacks the connector, and employs fingers that are either straight or include only a single bend. This results in less obstruction by conductive material and a wider spacing between fingers, allowing more external light to pass through.

By combining the removal of certain insulating layers with the simplified geometry of the pixel electrode, the apparatus increases the optical clarity of the sensing area without affecting the operation of the remaining display. This configuration is specifically tailored to enhance the accuracy and responsiveness of optical detection components located behind the panel.

Accordingly, the present disclosure is directed to a display apparatus that substantially obviates one or more problems due to limitations and disadvantages of the related art.

For example, an aspect of the present disclosure is to provide a display apparatus capable of improving the transmittance of a sensing area of a liquid crystal display panel to increase the recognition rate of an optical element.

The aspects of the present disclosure are not limited to the above-described aspect. The aspects of the present disclosure that are not mentioned herein will be clearly understood by those skilled in the art from the following description.

Additional advantages, aspects, and features of the disclosure will be set forth in part in the description which follows and in part will become apparent to those having ordinary skill in the art upon examination of the following or may be learned from practice of the disclosure. The aspects and other advantages of the disclosure may be realized and attained by the structure particularly pointed out in the written description and claims hereof as well as the appended drawings.

To achieve these aspects and other advantages and in accordance with the purpose of the disclosure, as embodied and broadly described herein, a display apparatus includes a liquid crystal display panel including an active area configured such that a plurality of gate lines and a plurality of data lines are alternately arranged thereon to define a plurality of subpixel areas, and a bezel area located outside the active area, the active area including a sensing area.

The display apparatus may include an optical element configured to detect external light having passed through the sensing area of the liquid crystal display panel or capture an image.

Each of the plurality of subpixel areas may include a thin film transistor and a pixel electrode, the thin film transistor may include a gate electrode, a semiconductor pattern, a drain electrode, a source electrode, a gate insulating film disposed between the gate electrode and the semiconductor pattern, and an element protection film configured to cover the semiconductor pattern, the drain electrode, and the source electrode, and the gate insulating film and the element protection film may not be disposed below the pixel electrode in each of the subpixel areas in the sensing area.

In another aspect of the present disclosure, a display apparatus including a liquid crystal display panel including an active area configured such that a plurality of gate lines and a plurality of data lines are alternately arranged thereon to define a plurality of subpixel areas, and a bezel area located outside the active area, the active area including a sensing area and an optical element configured to detect external light having passed through the sensing area of the liquid crystal display panel or capture an image, wherein each of the plurality of subpixel areas includes a thin film transistor and a pixel electrode, the pixel electrode disposed in the active area excluding the sensing area includes a first body connected to a source electrode of the thin film transistor disposed in the active area excluding the sensing area, a plurality of first fingers configured to extend from the first body, and a connector configured to electrically connect ends of the plurality of first fingers, and the pixel electrode disposed in the sensing area includes a second body connected to a source electrode of the thin film transistor disposed in the sensing area, and a plurality of second fingers configured to extend from the second body.

A shape of the first fingers may be different from a shape of the second fingers.

The details of other aspects are included in the detailed description and drawings.

It is to be understood that both the foregoing general description and the following detailed description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is view schematically showing a display apparatus according to one embodiment of the present disclosure;

FIG. 2 is a cross-sectional view taken along lines I-I′ and II-II′ of FIG. 1;

FIG. 3 is a circuit diagram of a subpixel area located in a liquid crystal panel in the display apparatus according to one embodiment of the present disclosure;

FIG. 4 is a plan view showing subpixel areas of the liquid crystal display panel according to one embodiment of the present disclosure;

FIG. 5 is a cross-sectional view taken along line III-III′ of FIG. 4, which is a cross-sectional view of a subpixel area disposed in an active area of the liquid crystal display panel according to one embodiment of the present disclosure excluding than a sensing area;

FIG. 6 is a cross-sectional view taken along line III-III′ of FIG. 4, which is a cross-sectional view of a subpixel area disposed in the sensing area of the liquid crystal display panel according to one embodiment of the present disclosure;

FIG. 7 is a plan view of a pixel electrode disposed in an active area of a liquid crystal display panel according to another embodiment of the present disclosure excluding a sensing area;

FIG. 8 is a plan view of a pixel electrode disposed in the sensing area of the liquid crystal display panel according to another embodiment of the present disclosure;

FIG. 9 is a plan view of fingers of a pixel electrode disposed in an active area of a liquid crystal display panel according to yet another embodiment of the present disclosure excluding a sensing area;

FIG. 10 is a cross-sectional view taken along line IV-IV′ of FIG. 9;

FIG. 11 is a plan view of fingers of a pixel electrode arranged in the sensing area of the liquid crystal display panel according to yet another embodiment of the present disclosure; and

FIG. 12 is a cross-sectional view taken along line IV-IV′ of FIG. 11.

### DETAILED DESCRIPTION

The aspects and technical configurations of the present disclosure and the resulting operational effects will be more clearly understood by the following detailed description with reference to the drawings illustrating embodiments of the present disclosure. Here, since the embodiments of the present disclosure are provided to fully convey the technical idea of the present disclosure to those skilled in the art, the present disclosure may be embodied in other forms so as not to be limited to the embodiments described below.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In addition, when a first component is referred to as being “on” a second component, the first component may be directly on the second component, or a third component may be located between the first component and the second component.

Here, the terms “first,” “second,” etc., are used to describe various components and are used for the purpose of distinguishing one component from another. However, the first component and the second component may be arbitrarily named according to the convenience of those skilled in the art without departing from the technical spirit of the present disclosure.

The terms used in the description of the present disclosure are used only to describe specific embodiments and are not intended to limit the present disclosure. For example, a component expressed in the singular includes plural components unless the context clearly indicates otherwise. In addition, the terms “comprises,” “comprising,” “including,” and “having” are inclusive and therefore specify the presence of stated features, integers, steps, operations, elements, and/or components, but do not preclude the possibility of the presence or addition of one or more other features, integers, steps, operations, elements, components, and/or groups thereof.

As used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

In addition, unless otherwise defined, all terms used herein, including technical or scientific terms, have the same meanings as generally understood by those skilled in the art to which the present disclosure pertains. Terms defined in commonly used dictionaries should be interpreted as having meanings consistent with their meanings in the context of the relevant art, and will not be interpreted as having ideal or excessively formal meanings unless the context defines the meanings explicitly.

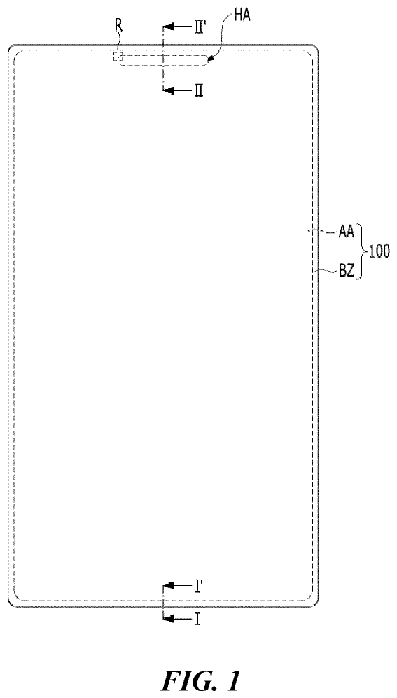

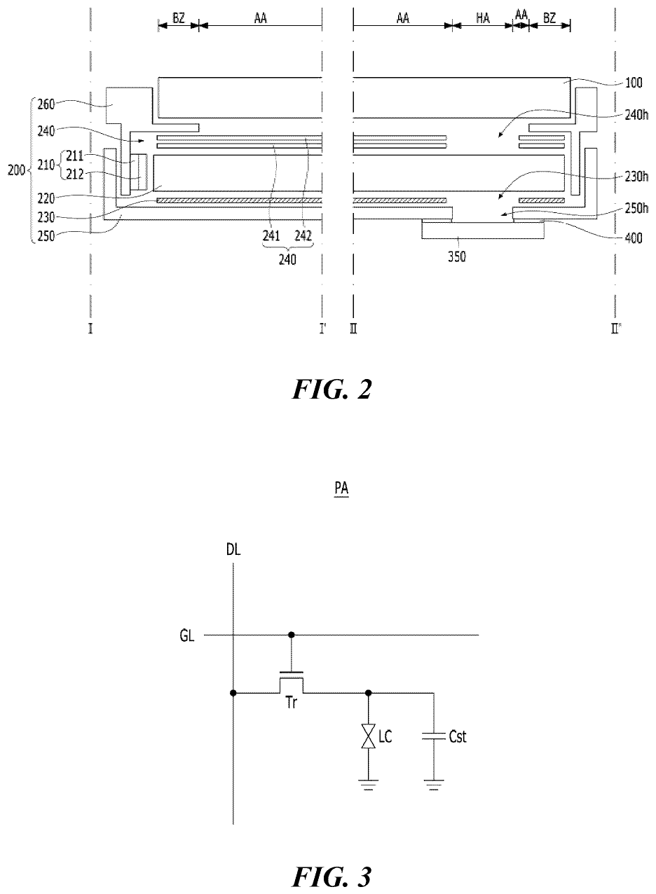

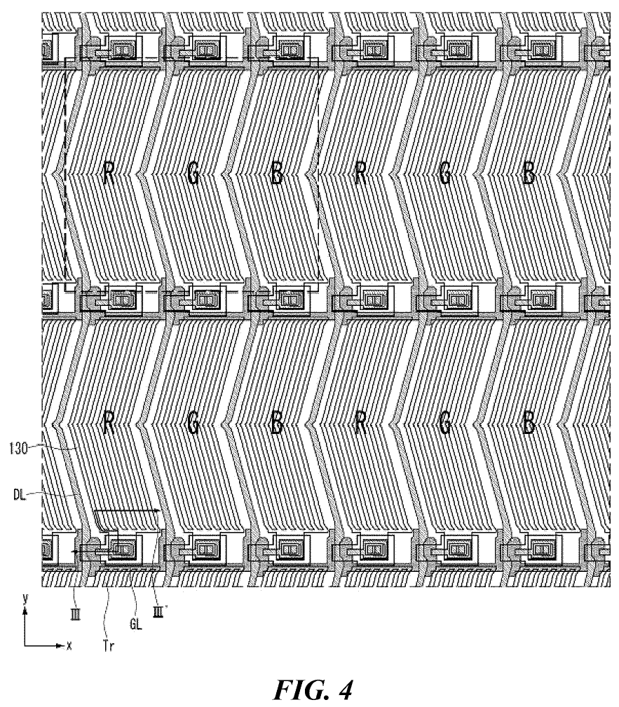

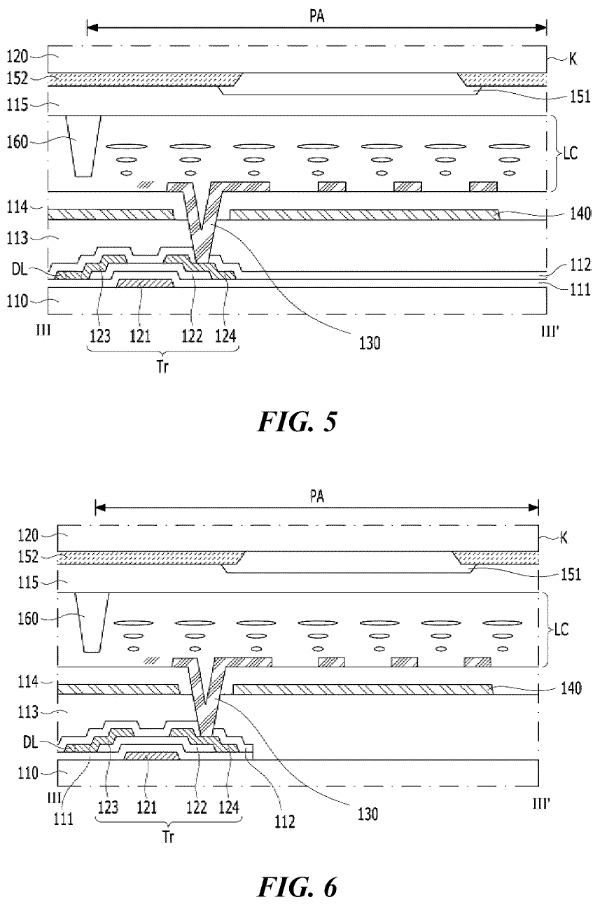

FIG. 1 is view schematically showing a display apparatus according to one embodiment of the present disclosure. FIG. 2 is a cross-sectional view taken along lines I-I′ and II-II′ of FIG. 1. FIG. 3 is a circuit diagram of a subpixel area located in a liquid crystal panel in the display apparatus according to one embodiment of the present disclosure. FIG. 4 is a plan view showing subpixel areas of the liquid crystal display panel according to one embodiment of the present disclosure. FIG. 5 is a cross-sectional view taken along line III-III′ of FIG. 4, which is a cross-sectional view of a subpixel area PA disposed in an active area AA of the liquid crystal display panel according to one embodiment of the present disclosure excluding a sensing area.

Referring to FIGS. 1 to 5, a display apparatus according to one embodiment of the present disclosure may include a liquid crystal display panel 100 for displaying an image, a backlight unit 200 located below the liquid crystal display panel 100 to provide light to the liquid crystal display panel 100, and an optical element 350 located below the liquid crystal display panel 100 to capture an image or to detect external light through a sensing area HA of the liquid crystal display panel 100.

The liquid crystal display panel 100 may include a plurality of subpixel areas PA. Various signals may be applied to each subpixel area PA through signal lines GL and DL. For example, the signal lines GL and DL may include gate lines GL for sequentially applying gate signals, and data lines DL for applying data signals. The gate lines GL may intersect the data lines DL. For example, the gate lines GL may extend in a first direction, and the data lines DL may extend in a second direction perpendicular to the first direction. The data lines DL may be located on a different layer from the gate lines GL. The data lines DL may be located on a different layer from the gate lines GL.

The liquid crystal display panel 100 may include an active area AA in which the subpixel areas PA are located, and a bezel area BZ located outside the active area AA. The bezel area BZ may not overlap the subpixel areas PA. For example, the active area AA may be surrounded by the bezel area BZ. A gate driver electrically connected to the gate lines GL and a data driver electrically connected to the data lines DL may be located outside the active area AA. For example, each signal line GL or DL may include an area overlapping the bezel area BZ of the liquid crystal display panel 100.

The liquid crystal display panel 100 may include a liquid crystal layer LC located between a first display substrate 110 and a second display substrate 120. The first display substrate 110 and the second display substrate 120 may include an insulating material. The first display substrate 110 and the second display substrate 120 may include a transparent material. For example, the first display substrate 110 and the second display substrate 120 may include glass or plastic. The second display substrate 120 may include a material different from the first display substrate 110. The liquid crystal layer LC may include liquid crystals manipulated using various technologies. For example, the liquid crystals of the liquid crystal layer LC may be manipulated using the in-plane switching (IPS) technology or the fringe field switching (FFS) technology. The liquid crystals of the liquid crystal layer LC overlapping each subpixel area PA may be rotated by a vertical electric field or a horizontal electric field formed in the corresponding subpixel area PA by the gate signal and the data signal. For example, a pixel electrode 130 for forming a horizontal electric field and a common electrode 140 overlapping some areas of the pixel electrode 130 may be located in each subpixel area PA.

A constant power voltage may be supplied to the common electrode 140 of each subpixel area PA. A driving voltage corresponding to the data signal applied to the corresponding subpixel area PA may be supplied to the pixel electrode 130 of the corresponding subpixel area PA according to the gate signal applied to the corresponding subpixel area PA. That is, in the display apparatus according to one embodiment of the present disclosure, a horizontal electric field may be formed in each subpixel area PA by the driving voltage applied to the pixel electrode 130 of the corresponding subpixel area PA and the power voltage applied to the common electrode 140. The driving voltage applied to the pixel electrode 130 of each subpixel area PA may be maintained for one frame. For example, at least one thin film transistor Tr and a storage capacitor Cst may be located in each subpixel area PA.

The thin film transistor Tr of each subpixel area PA may generate a driving voltage corresponding to a data signal applied to the corresponding subpixel area PA according to a gate signal applied to the corresponding subpixel area PA. The thin film transistor Tr of each subpixel area PA may be electrically connected to one of the gate lines GL and one of the data lines DL. For example, the thin film transistor Tr of each subpixel area PA may include a gate electrode 121 electrically connected to one of the gate lines GL, a semiconductor pattern 122 including a region overlapping the gate electrode 121, a drain electrode 123 electrically connected to one end of the semiconductor pattern 122, and a source electrode 124 electrically connected to the other end of the semiconductor pattern 122.

The gate electrode 121 may include a conductive material. For example, the gate electrode 121 may include a metal, such as aluminum (Al), chromium (Cr), copper (Cu), molybdenum (Mo), titanium (Ti), or tungsten (W). The semiconductor pattern 122 may be located on the gate electrode 121. The semiconductor pattern 122 may include a semiconductor material. For example, the semiconductor pattern 122 may include amorphous silicon (a-Si), polycrystalline silicon (poly-Si), or an oxide semiconductor, such as IGZO. The semiconductor pattern 122 may include a channel region located between a drain region and a source region. For example, the gate electrode 121 may overlap the channel region of the semiconductor pattern 122. The drain region and the source region of the semiconductor pattern 122 may be located outside the gate electrode 121.

The drain region and the source region of the semiconductor pattern 122 may have a lower resistance than the channel region of the semiconductor pattern 122. For example, the drain region and the source region of the semiconductor pattern 122 may include a conducting region of an oxide semiconductor. The channel region of the semiconductor pattern 122 may be a non-conducting region of an oxide semiconductor. The semiconductor pattern 122 may be spaced apart from the gate electrode 121. The semiconductor pattern 122 may be insulated from the gate electrode 121. For example, the channel region of the semiconductor pattern 122 may have electrical conductivity corresponding to the voltage supplied to the gate electrode 121. The drain region of the semiconductor pattern 122 may be electrically connected to the source region of the semiconductor pattern 122 according to a signal applied to the gate electrode 121.

The drain electrode 123 and the source electrode 124 may include a conductive material. For example, the drain electrode 123 and the source electrode 124 may include a metal, such as aluminum (Al), chromium (Cr), copper (Cu), molybdenum (Mo), titanium (Ti), or tungsten (W). The drain electrode 123 and the source electrode 124 may include a different material from the gate electrode 121. For example, the drain electrode 123 and the source electrode 124 may be located on a different layer from the gate electrode 121. The source electrode 124 may be located on the same layer as the drain electrode 123. The source electrode 124 may include the same material as the drain electrode 123. The source electrode 124 may be formed by the same process as the drain electrode 123. For example, the source electrode 124 may be formed simultaneously with the drain electrode 123.

The drain electrode 123 may be electrically connected to the drain region of the semiconductor pattern 122. The source electrode 124 may be electrically connected to the source region of the semiconductor pattern 122. The drain electrode 123 and the source electrode 124 may be insulated from the gate electrode 121. The source electrode 124 may be spaced apart from the drain electrode 123. For example, the drain electrode 123 of each subpixel area PA may be electrically connected to one of the data lines DL. The drain electrode 123 may be formed integrally with one of the data lines DL. The pixel electrode 130 of each subpixel area PA may be electrically connected to the source electrode 124 of the corresponding subpixel area PA.

The storage capacitor Cst of each subpixel area PA may maintain a signal applied to the gate electrode 121 of the corresponding subpixel area PA for one frame. For example, the storage capacitor Cst of each subpixel area PA may be electrically connected to the gate electrode 121 of the corresponding subpixel area PA and a power voltage supply line that supplies the power voltage.

The thin film transistor Tr and the storage capacitor Cst of each subpixel area PA may be located between the first display substrate 110 and the liquid crystal layer LC. A plurality of insulating films 111, 112, 113, and 114 may be located between the first display substrate 110 and the liquid crystal layer LC to prevent unnecessary conductive connection. For example, a gate insulating film 111, an element protection film 112, a planarization film 113, and an interlayer insulating film 114 may be located between the first display substrate 110 and the liquid crystal layer LC.

The gate insulating film 111 may be located close to the first display substrate 110. The semiconductor pattern 122 of each subpixel area PA may be insulated from the gate electrode 121 of corresponding subpixel area PA by the gate insulating film 111. For example, the gate insulating film 111 may cover the gate electrode 121 of each subpixel area PA. The semiconductor pattern 122 of each subpixel area PA may be located on the gate insulating film 111. Each of the drain electrode 123 and the source electrode 124 of each subpixel area PA may be in direct contact with a portion of the semiconductor pattern 122 located within the corresponding subpixel area PA. For example, the drain electrode 123 and the source electrode 124 of each subpixel area PA may be located on the gate insulating film 111. The gate insulating film 111 may include an insulating material. For example, the gate insulating film 111 may include an inorganic insulating material, such as silicon oxide (SiOₓ) or silicon nitride (SiNₓ).

The element protection film 112 may be located on the gate insulating film 111. The element protection film 112 may prevent damage to the thin film transistor Tr located in each subpixel area PA due to external impact and moisture. For example, the semiconductor pattern 122, the drain electrode 123, and the source electrode 124 of each subpixel area PA may be covered by the element protection film 112. The element protection film 112 may include an insulating material. For example, the element protection film 112 may include an inorganic insulating material, such as silicon oxide (SiOₓ) or silicon nitride (SiNₓ).

The planarization film 113 may be located on the element protection film 112. The planarization film 113 may remove steps caused by the thin film transistor Tr and the storage capacitor Cst of each subpixel area PA. For example, the upper surface of the planarization film 113 facing the liquid crystal layer LC may be parallel to the upper surface of the first display substrate 110 facing the liquid crystal layer LC. The planarization film 113 may include an insulating material. The planarization film 113 may include a material different from the element protection film 112. The planarization film 113 may include a material having relatively high fluidity. For example, the planarization film 113 may include an organic insulating material.

The common electrode 140 may be located on the planarization film 113. The interlayer insulating film 114 may be located between the planarization film 113 and the liquid crystal layer LC. The common electrode 140 of each subpixel area PA may be insulated from the pixel electrode 130 of the corresponding subpixel area PA by the interlayer insulating film 114. For example, the interlayer insulating film 114 may cover the common electrode 140 of each subpixel area PA. The pixel electrode 130 of each subpixel area PA may be located between the interlayer insulating film 114 and the liquid crystal layer LC. Each pixel electrode 130 may have at least one slit. The interlayer insulating film 114 may include an insulating material. For example, the interlayer insulating film 114 may include an inorganic insulating material.

Color filters 151, a black matrix 152, and an upper protective film 115 may be located between the liquid crystal layer LC and the second display substrate 120. The color filters 151 may overlap the subpixel areas PA. For example, each color filter 151 may overlap one of the subpixel areas PA. Each color filter 151 may represent a specific color using light having passed through the liquid crystal layer LC. For example, light having passed through each color filter 151 may represent one of red, blue, and green. The black matrix 152 may be located parallel to the color filters 151. For example, the end of each color filter 151 may overlap the black matrix 152. FIG. 4 illustrates that the end of each color filter 151 overlaps the black matrix 152 and the ends of two adjacent color filters 151 do not overlap each other on the black matrix 152, but the present disclosure is not limited thereto. The ends of two adjacent color filters 151 may overlap each other on the black matrix 152.

The black matrix 152 may include a material capable of reflecting or absorbing light. For example, light having passed through the liquid crystal layer LC of each subpixel area PA may pass through the color filter 151 of the corresponding subpixel area PA located within an area defined by the black matrix 152, and be emitted to the outside. Accordingly, in the display apparatus according to one embodiment of the present disclosure, an image including various colors may be provided to a user.

The black matrix 152 may overlap the signal lines GL and DL. The thin film transistor Tr and the storage capacitor Cst of each subpixel area PA may overlap the black matrix 152. Therefore, in the display apparatus according to one embodiment of the present disclosure, the signal lines GL and DL and the thin film transistor Tr and the storage capacitor Cst of each subpixel area PA may not be recognized by the user due to the black matrix 152. That is, in the display apparatus according to one embodiment of the present disclosure, deterioration of the quality of an image caused by recognition of the signal lines GL and DL and the thin film transistor Tr and the storage capacitor Cst of each subpixel area PA by the user may be prevented. The color filters 151 and the black matrix 152 may be covered by the upper protective film 115. The upper protective film 115 may prevent damage to the color filters 151 and the black matrix 152 due to external impact and moisture. The upper protective film 115 may include an insulating material. For example, the upper protective film 115 may include an inorganic insulating material, such as silicon oxide (SiOₓ) or silicon nitride (SiNₓ).

A spacer 160 may be located between the interlayer insulating film 114 and the upper protective film 115. The spacer 160 may maintain a constant gap between the interlayer insulating film 114 and the upper protective film 115. Accordingly, in the display apparatus according to one embodiment of the present disclosure, the liquid crystal layer LC of each subpixel area PA may have the same thickness. Therefore, in the display apparatus according to one embodiment of the present disclosure, light passing through the liquid crystal layer LC of each subpixel area PA may have the same optical path. In addition, in the display apparatus according to one embodiment of the present disclosure, light having passed through the liquid crystal layer LC of each subpixel area PA may have the same luminance as light having passing through the liquid crystal layer LC of a subpixel area PA in which the same horizontal electric field as the corresponding subpixel area PA is formed.

The liquid crystal display panel 100 may be located above the backlight unit 200. The backlight unit 200 may supply light to the liquid crystal display panel 100. For example, the liquid crystal display panel 100 may generate an image to be provided to a user using the light supplied from the backlight unit 200. The backlight unit 200 may include a light source element 210, a light guide plate 220, a reflector 230, an optical sheet 240, a bottom cover 250, and a middle frame 260.

The light source element 210 may supply light to the liquid crystal display panel 100 through the light guide plate 220. For example, the light source element 210 may be located on one side surface of the light guide plate 220. The light source element 210 may include a self-luminous element that may generate and emit light. For example, the light source element 210 may include an LED.

The reflector 230 may be located on the lower surface of the light guide plate 220. The lower surface of the light guide plate 220 may face the upper surface of the light guide plate 220. For example, the light guide plate 220 may be located between the reflector 230 and the liquid crystal display panel 100. The reflector 230 may include a material capable of reflecting light. For example, the reflector 230 may include a metal, such as aluminum (Al) or silver (Ag). Accordingly, in the display apparatus according to one embodiment of the present disclosure, light emitted through the lower surface of the light guide plate 220 may be reflected toward the liquid crystal display panel 100 by the reflector 230.

The optical sheet 240 may be located between the light guide plate 220 and the liquid crystal display panel 100. Light supplied to the liquid crystal display panel 100 through the light guide plate 220 may have uniform luminance by the optical sheet 240. For example, the optical sheet 240 may have a stacked structure of a prism sheet 241 and a diffusion sheet 242. Therefore, in the display apparatus according to one embodiment of the present disclosure, light may be supplied uniformly to the entire area of the liquid crystal display panel 100.

The light source element 210, the light guide plate 220, the reflector 230, and the optical sheet 240 may be accommodated in the bottom cover 250. The bottom cover 250 may include an insulating material. For example, the bottom cover 250 may include plastic. The bottom cover 250 may include a bottom surface and side walls protruding from the edge of the bottom surface. The reflector 230 may be located between the light guide plate 220 and the bottom surface of the bottom cover 250. The light source element 210, the light guide plate 220, and the optical sheet 240 may be located within a space formed by the side walls of the bottom cover 250. For example, the side walls of the bottom cover 250 may surround the light source element 210, the light guide plate 220, and the optical sheet 240.

The middle frame 260 may support the liquid crystal display panel 100. The middle frame 260 may be coupled to the bottom cover 250. For example, the middle frame 260 may include a coupling area extending between the bottom cover 250 and the light guide plate 220. The light source element 210 may be fixed to the coupling area of the middle frame 260. For example, the light source element 210 may be attached to the coupling area of the middle frame 260 by an adhesive member. The middle frame 260 may include a mounting area extending between the optical sheet 240 and the liquid crystal display panel 100. The mounting area of the middle frame 260 may overlap the edge of the optical sheet 240. For example, the mounting area of the middle frame 260 may overlap the bezel area BZ of the liquid crystal display panel 100. The active area AA of the liquid crystal display panel 100 may not overlap the mounting area of the middle frame 260. For example, a central area of the optical sheet 240 may be exposed from the middle frame 260. The mounting area of the middle frame 260 may be in direct contact with the optical sheet 240. Accordingly, in the display apparatus according to one embodiment of the present disclosure, movement of the optical sheet 240 may be prevented by the middle frame 260.

The reflector 230 may include a through hole 230h that overlaps the sensing area HA of the liquid crystal display panel 100. The optical sheet 240 may include a sheet hole 240h that overlaps the sensing area HA of the liquid crystal display panel 100. The bottom cover 250 may include a cover hole 250h that overlaps the sensing area HA of the liquid crystal display panel 100.

The optical element 350 may detect external light having passed through the sensing area HA of the liquid crystal display panel 100 and the backlight unit 200 or capture an image. For example, the optical element 350 may include at least one of a camera or an IR sensor. The optical element 350 may be located below the backlight unit 200. The optical element 350 may be attached to the rear surface of the bottom cover 250 by an adhesive tape 400. However, the present disclosure is not limited thereto. The optical element 350 may be attached to the rear surface of the bottom cover 250 by a fastening means, such as a screw.

The structure of a subpixel area PA disposed in the active area AA of the liquid crystal display panel 100 and the structure of a subpixel area PA disposed in the sensing area HA may be different from each other. This will be described in detail as follows.

FIG. 6 is a cross-sectional view taken along line III-III′ of FIG. 4, i.e., a cross-sectional view of a subpixel area disposed in the sensing area HA of the liquid crystal display panel according to one embodiment of the present disclosure.

FIG. 5 is a cross-sectional view of the subpixel area disposed in the active area AA excluding the sensing area HA, and FIG. 6 is a cross-sectional view of the subpixel area disposed in the sensing area HA of the liquid crystal display panel according to one embodiment of the present disclosure. Comparing FIGS. 5 and 6, there is a difference in the gate insulating film 111 and the element protection film 112. Therefore, the gate insulating film 111 and the element protection film 112 will be described, and the description of the remaining configuration will be omitted.

As illustrated in FIG. 6, the liquid crystal display panel 100 according to one embodiment of the present disclosure may include the liquid crystal layer LC located between the first display substrate 110 and the second display substrate 120. The at least one thin film transistor Tr and the storage capacitor Cst may be located in each subpixel area PA.

The thin film transistor Tr of each subpixel area PA may include the gate electrode 121 electrically connected to one of the gate lines GL, the semiconductor pattern 122 including a region overlapping the gate electrode 121, the drain electrode 123 electrically connected to one end of the semiconductor pattern 122, and the source electrode 124 electrically connected to the other end of the semiconductor pattern 122.

The gate insulating film 111 may be located between the gate electrode 121 and the semiconductor pattern 122 of the thin film transistor Tr. In addition, the element protection film 112 may be located between the semiconductor pattern 122, the drain electrode 123, and the source electrode 124 of the thin film transistor Tr and the planarization film 113.

In FIG. 5, the gate insulating film 111 and the element protection film 112 are not only located on the thin film transistor Tr, but also on the entire surface of the subpixel area PA. For example, the gate insulating film 111 and the element protection film 112 are also located below the pixel electrode 130.

However, in FIG. 6, the gate insulating film 111 and the element protection film 112 are only located on the thin film transistor Tr but are not located on the remainder of the subpixel area PA. For example, the gate insulating film 111 and the element protection film 112 are not located below the pixel electrode 130.

As shown in FIG. 6, since inorganic insulating films, such as the gate insulating film 111 and the element protection film 112, are not formed below the pixel electrode 130 in each subpixel area of the sensing area HA of the liquid crystal display panel, the transmittance of the sensing area HA of the liquid crystal display panel may be improved by about 5.85%.

Further, the transmittance may be improved by changing the disposition of the pixel electrode.

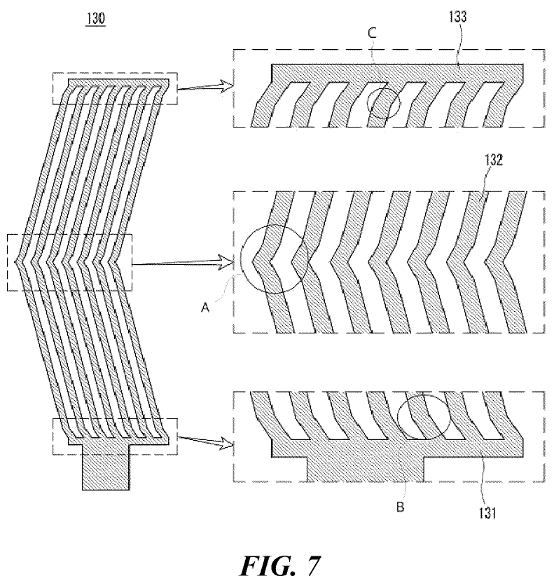

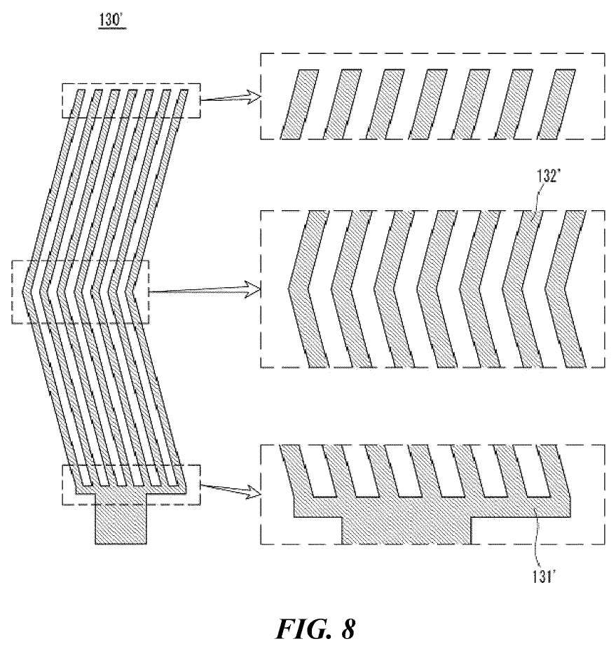

FIG. 7 is a plan view of a pixel electrode disposed in an active area AA of a liquid crystal display panel according to another embodiment of the present disclosure excluding a sensing area HA. FIG. 8 is a plan view of a pixel electrode disposed in the sensing area HA of the liquid crystal display panel according to another embodiment of the present disclosure.

A pixel electrode 130 disposed in the active area AA of the liquid crystal display panel according to another embodiment of the present disclosure excluding the sensing area HA may include, as shown in FIG. 7, a first body 131 connected to the source electrode 124 of the thin film transistor Tr described in FIG. 5, a plurality of first finger portions 132 (or simply ‘a plurality of first fingers 132’) extending from the body 131 in a direction parallel to the data line DL, and a connector 133 that electrically connect ends of the plurality of first fingers 132.

The plurality of first fingers 132 may have a structure that is bent in a certain direction at a point of where each of the plurality of first fingers 132 is connected to the first body 131. The plurality of first fingers 132 may have a structure (i.e., a composite angle structure) that is bent at multiple angles at a central portion of each of the plurality of first fingers 132. The plurality of first fingers 132 may have the structure that is bent in a certain direction at a point where each of the plurality of first fingers 132 is connected to the connector 133.

For example, as shown in FIG. 7, the plurality of first fingers 132 may have the structure that is bent in a certain direction at the point where each of the plurality of first fingers 132 is connected to the first body 131, as shown by “B”. The plurality of first fingers 132 may have the structure (i.e., the composite angle structure) that is bent at multiple angles at the central portion of each of the plurality of first fingers 132, as shown by “A”. The plurality of first fingers 132 may have the structure that is bent in a certain direction at the point where each of the plurality of first fingers 132 is connected to the connector 133, as shown by “C”.

On the other hand, a pixel electrode 130′ disposed in the sensing area HA of the liquid crystal display panel according to another embodiment of the present disclosure may have, as shown in FIG. 8, a second body 131′ connected to the source electrode 124 of the thin film transistor Tr described in FIG. 5, and a plurality of second finger portions 132′ (or simply ‘a plurality of second fingers 132′’) extending from the second body 131′ in a direction parallel to the data line DL.

The plurality of second fingers 132′ may not have a structure that is bent at a point where each of the plurality of second fingers 132′ is connected to the second body 131′. The plurality of second fingers 132′ may have a structure that is bent at a certain angle at a central portion of each of the plurality of second fingers 132′. The plurality of second fingers 132′ may not have a structure (i.e., a composite angle structure) that is bent at multiple angles at the central portion of each of the plurality of second fingers 132′.

Comparing FIGS. 7 and 8, the pixel electrode 130 disposed in the active area AA of the liquid crystal display panel according to another embodiment of the present disclosure excluding the sensing area HA may include the connector 133 that electrically connects the ends of the plurality of first fingers 132. However, the pixel electrode 130′ disposed in the sensing area HA of the liquid crystal display panel according to another embodiment of the present disclosure may not include the connector 133.

The plurality of first fingers 132 of the pixel electrode 130 disposed in the active area AA of the liquid crystal display panel according to another embodiment of the present disclosure excluding the sensing area HA may have the structure (composite angle structure) that is bent at multiple angles at the central portion of each of the plurality of first fingers 132. However, the plurality of second fingers 132′ of the pixel electrode 130′ disposed in the sensing area HA of the liquid crystal display panel according to another embodiment of the present disclosure may not have a structure (composite angle structure) that is bent at multiple angles at the central portion of each of the plurality of second fingers 132′.

As such, since the pixel electrode 130′ disposed in the sensing area HA of the liquid crystal display panel according to another embodiment of the present disclosure does not include the connector 133 and the plurality of second fingers 132′ of the pixel electrode 130′ do not have the structure (composite angle structure) that is bent at multiple angles at the central portion of each of the plurality of second fingers 132′, the transmittance of the sensing area HA of the liquid crystal display panel may be improved.

Further, the number of second fingers 132′ of a pixel electrode 130′ disposed in a sensing area HA of a liquid crystal display panel according to yet another embodiment of the present disclosure may be reduced.

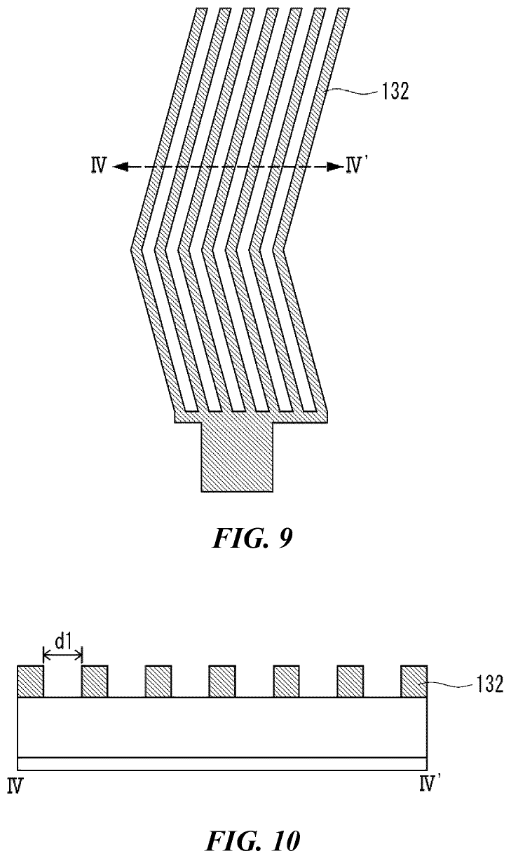

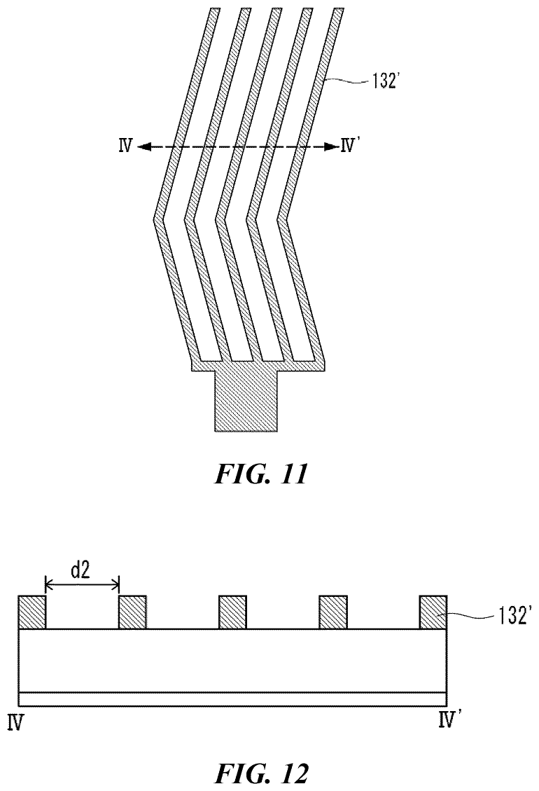

FIG. 9 is a plan view of first fingers of a pixel electrode disposed in an active area AA of a liquid crystal display panel according to yet another embodiment of the present disclosure excluding a sensing area HA. FIG. 10 is a cross-sectional view taken along line IV-IV′ of FIG. 9. FIG. 11 is a plan view of second fingers of a pixel electrode arranged in the sensing area HA of the liquid crystal display panel according to yet another embodiment of the present disclosure. FIG. 12 is a cross-sectional view taken along line IV-IV′ of FIG. 11.

As described with reference to FIGS. 7 and 8, a pixel electrode 130 or 130′ may include a first or second body 131 or 131′ connected to the source electrode 124 of the thin film transistor Tr, and a plurality of first or second fingers 132 or 132′ extending from the first or second body 131 or 131′ in a direction parallel to the data line DL.

As shown in FIGS. 9 to 12, the number of the second fingers 132′ of the pixel electrode 130′ disposed in each subpixel area in the sensing area HA of the liquid crystal display panel may be reduced compared to the number of the first fingers 132 of the pixel electrode 130 disposed in each subpixel area in the active area AA of the liquid crystal display panel excluding the sensing area HA.

For example, as shown in FIGS. 9 and 10, the number of the first fingers 132 of the pixel electrode 130 disposed in each subpixel area in the active area AA of the liquid crystal display panel excluding the sensing area HA may be set to 7. Accordingly, the first fingers 132 of the pixel electrode 130 disposed in each subpixel area in the active area AA of the liquid crystal display panel excluding the sensing area HA may have a predetermined distance d1 therebetween.

On the other hand, as shown in FIGS. 11 and 12, the number of the second fingers 132′ of the pixel electrode 130′ disposed in each subpixel area in the sensing area HA of the liquid crystal display panel may be set to 5. Accordingly, the second fingers 132 of the pixel electrode 130′ disposed in each subpixel area in the sensing area HA of the liquid crystal display panel may have a predetermined distance d2 therebetween. Here, the distance d1 may be less than the distance d2.

As such, since the number of the second fingers 132′ of the pixel electrode 130′ disposed in the sensing area HA of the liquid crystal display panel according to yet another embodiment of the present disclosure is reduced compared to the number of the first fingers 132 of the pixel electrode 130 disposed in the active area AA of the liquid crystal display panel excluding the sensing area HA, the transmittance of the sensing area HA of the liquid crystal display panel may be improved.

Additional embodiments of a display apparatus are described herein, which may include variations in structural configuration and subpixel arrangement to enhance optical performance, particularly in regions designated for sensing functions.

For example, a display apparatus may include a liquid crystal display panel that comprises a substrate 110, which may be formed of a transparent insulating material such as glass or plastic. A liquid crystal layer LC is disposed on the substrate 110. The liquid crystal layer LC may be manipulated via an electric field to modulate light passing through the panel. A plurality of subpixel areas may be arranged within an active area defined on the substrate. The active area may include a group of first subpixel areas that are located within a sensing area of the active area, and a group of second subpixel areas that are located outside the sensing area, such as in regions dedicated to image display.

Each subpixel area may include a thin film transistor (TFT), which may be formed on the substrate. The TFT may include a gate electrode, a semiconductor pattern disposed on or above the gate electrode, a source electrode and a drain electrode in electrical contact with the semiconductor pattern, and a pixel electrode disposed above the thin film transistor. The semiconductor pattern may include a channel region, and the pixel electrode may receive a signal from the TFT to control the orientation of liquid crystal molecules in the corresponding subpixel area.

In the second subpixel areas, which may be outside the sensing region, a gate insulating film 111 and an element protection film 112 are disposed below the pixel electrode 130. These layers may comprise insulating materials such as silicon nitride or silicon oxide and may function to electrically isolate and protect the underlying transistor structures. In contrast, in the first subpixel areas, located within the sensing area HA, both the gate insulating film 111 and the element protection film 112 are omitted in the region below the pixel electrode 130, such that the pixel electrode 130 is disposed directly above other dielectric layers, which may include, for example, a planarization film 113 or an interlayer insulating film 114. The selective omission of these films in the sensing area HA may reduce optical absorption and scattering, thereby improving transmittance.

In some embodiments, each pixel electrode in the second subpixel areas may include a first body 131 extending in a first direction. A plurality of first finger portions may extend from the first body 131 in a second direction transverse to the first direction. The fingers may be configured to form electric fields that align the liquid crystal molecules in a desired orientation, such as in-plane or fringe field configurations. The first direction may be parallel to a gate line, and the second direction may be parallel to a data line, or vice versa, depending on the specific electrode layout.

In certain implementations, a connector 133 may be provided that electrically connects distal ends of the plurality of first finger portions. The connector 133 may extend in parallel with the first body and be formed on the same conductive layer as the first fingers and first body. This structure may enclose the finger pattern, forming a closed-loop or comb-shaped electrode with a conductive bridge, which contributes to improved voltage uniformity across the subpixel.

Each of the first finger portions may include at least two angular bends located along its length between its proximal end, which connects to the first body, and its distal end, which may connect to the connector 133. At least one of the bends may be located near a central area of the respective finger portion. This geometry may define a non-linear finger shape, which increases the effective surface area or modulates electric field distribution for liquid crystal alignment.

In the first subpixel areas, each pixel electrode may include a second body and a plurality of second finger portions extending from the second body. The second finger portions may be unconnected at their distal ends, meaning that no bridging or connector element spans across the tips of the fingers. This design may be implemented to reduce or minimize conductive material in the optical path and thus enhance light transmittance in the sensing region.

Each of the second finger portions may be linear, or alternatively, may include a single bend along their length. The geometry of these fingers is generally simpler compared to those in the second subpixel areas and is optimized to reduce or minimize light obstruction and interference in the sensing area, particularly where a camera or optical sensor is located beneath the panel.

In some embodiments, first pixel electrodes in the second subpixel areas may include a first body extending in a first direction and a plurality of first finger portions extending from the first body in a second direction transverse to the first direction, with the distal ends of the finger portions connected by a connector. Meanwhile, second pixel electrodes in the first subpixel areas may include a second body and a plurality of second finger portions extending from the second body, with the distal ends of the second finger portions unconnected. Furthermore, the number of second finger portions in each first subpixel area may be fewer than the number of first finger portions in each second subpixel area. For example, the first pixel electrodes may include seven finger portions while the second pixel electrodes may include five finger portions.

In related embodiments, the spacing between adjacent second finger portions in the first subpixel areas may be greater than the spacing between adjacent first finger portions in the second subpixel areas. This increased spacing may further improve optical transmittance by increasing the aperture ratio within the sensing area.

In some embodiments, the second finger portions may be positioned in parallel with a data line extending through the corresponding subpixel area. The second finger portions may terminate at positions between adjacent gate lines, such that they do not cross or contact those lines. This spatial arrangement may be selected to reduce parasitic capacitance and improve sensing performance in optical applications.

In certain configurations, the omission of both the gate insulating film and the element protection film beneath the pixel electrode in each first subpixel area may result in increased optical transmittance relative to the second subpixel areas. This improved transmittance may enhance the effectiveness of an optical sensor, such as a camera or ambient light sensor, disposed beneath the panel and aligned with the sensing area.

As is apparent from the above description, a display apparatus according to the technical idea of the disclosure has the following technical benefits.

First, since inorganic insulating films, such as a gate insulating film and an element protection film, are not formed below a pixel electrode in each subpixel area of a sensing area of a liquid crystal display panel, the transmittance of the sensing area of the liquid crystal display panel may be improved.

Second, since the pixel electrode disposed in the sensing area of the liquid crystal display panel does not include a connector that electrically connects ends of a plurality of fingers, and the plurality of fingers of the pixel electrode does not have a structure (composite angle structure) that is bent at multiple angles at a central portion of each of the plurality of fingers, the transmittance of the sensing area of the liquid crystal display panel may be improved.

Third, since the number of the plurality of the fingers of the pixel electrode disposed in the sensing area is less than the number of a plurality of fingers of a pixel electrode disposed in an active area of the liquid crystal display panel excluding the sensing area, the transmittance of the sensing area of the liquid crystal display panel may be improved.

The effects according to the embodiments are not limited to the above description, and it will be understood that various other effects are encompassed by the disclosure.

The present disclosure described above is not limited to the above-described embodiments and the attached drawings, and it will be apparent to those skilled in the art to which the present disclosure pertains that various substitutions, modifications, and changes are possible without departing from the technical spirit of the present disclosure.

The various embodiments described above can be combined to provide further embodiments. These and other changes can be made to the embodiments in light of the above-detailed

description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a liquid crystal display panel comprising an active area configured such that a plurality of gate lines and a plurality of data lines are alternately arranged thereon to define a plurality of subpixel areas, and a bezel area located outside the active area, the active area comprising a sensing area; and
an optical element configured to detect external light having passed through the sensing area of the liquid crystal display panel or capture an image,
wherein:
each of the plurality of subpixel areas comprises a thin film transistor and a pixel electrode;
the thin film transistor comprises a gate electrode, a semiconductor pattern, a drain electrode, a source electrode, a gate insulating film disposed between the gate electrode and the semiconductor pattern, and an element protection film configured to cover the semiconductor pattern, the drain electrode, and the source electrode; and
the gate insulating film and the element protection film are not disposed below the pixel electrode in each of the subpixel areas in the sensing area.

2. The display apparatus according to claim 1, wherein:
the pixel electrode disposed in the active area excluding the sensing area comprises a first body connected to the source electrode of the thin film transistor disposed in the active area excluding the sensing area, a plurality of first fingers configured to extend from the first body, and a connector configured to electrically connect ends of the plurality of first fingers;
the pixel electrode disposed in the sensing area comprises a second body connected to the source electrode of the thin film transistor disposed in the sensing area, and a plurality of second fingers configured to extend from the second body; and
a shape of the first fingers is different from a shape of the second fingers.

3. The display apparatus according to claim 2, wherein:
the plurality of first fingers have a composite angle structure at a central portion of each thereof; and
the plurality of second fingers do not have the composite angle structure at a central portion of each thereof.

4. The display apparatus according to claim 2, wherein:
the plurality of first fingers have a structure configured to be bent in a certain direction at a point of each thereof connected to the first body; and
the plurality of second fingers do not have the structure configured to be bent at a point of each thereof connected to the second body.

5. The display apparatus according to claim 2, wherein:
the plurality of first fingers have a structure configured to be bent in a certain direction at a point of each thereof connected to the connector; and
the plurality of second fingers do not have the structure configured to be bent at ends of each thereof.

6. The display apparatus according to claim 2, wherein a number of the plurality of second fingers is less than a number of the plurality of first fingers.

7. The display apparatus according to claim 2, wherein a spacing between adjacent second fingers is greater than a spacing between adjacent first fingers.

8. The display apparatus according to claim 2, wherein ends of the plurality of second fingers are not connected to each other.

9. The display apparatus according to claim 2, wherein the plurality of second fingers have a structure configured to be bent in a certain direction at a central portion of each thereof.

10. The display apparatus comprising:
a liquid crystal display panel comprising an active area configured such that a plurality of gate lines and a plurality of data lines are alternately arranged thereon to define a plurality of subpixel areas, and a bezel area located outside the active area, the active area comprising a sensing area; and
an optical element configured to detect external light having passed through the sensing area of the liquid crystal display panel or capture an image,
wherein:
each of the plurality of subpixel areas comprises a thin film transistor and a pixel electrode;
the pixel electrode disposed in the active area excluding the sensing area comprises a first body connected to a source electrode of the thin film transistor disposed in the active area excluding the sensing area, a plurality of first fingers configured to extend from the first body, and a connector configured to electrically connect ends of the plurality of first fingers;
the pixel electrode disposed in the sensing area comprises a second body connected to a source electrode of the thin film transistor disposed in the sensing area, and a plurality of second fingers configured to extend from the second body; and
a shape of the first fingers is different from a shape of the second fingers.

11. The display apparatus according to claim 10, wherein:
the plurality of first fingers have a composite angle structure at a central portion of each thereof; and
the plurality of second fingers do not have the composite angle structure at a central portion of each thereof.

12. The display apparatus according to claim 10, wherein each of the plurality of first fingers includes at least two angular bends located along its length between its proximal and distal ends.

13. The display apparatus according to claim 10, wherein the plurality of second fingers are linear or includes a single bend along its length.

14. The display apparatus according to claim 10, wherein:
the plurality of first fingers have a structure configured to be bent in a certain direction at a point of each thereof connected to the first body; and
the plurality of second fingers do not have the structure configured to be bent at a point of each thereof connected to the second body.

15. The display apparatus according to claim 10, wherein:
the plurality of first fingers have a structure configured to be bent in a certain direction at a point of each thereof connected to the connector; and
the plurality of second fingers do not have the structure configured to be bent at ends of each thereof.

16. The display apparatus according to claim 10, wherein the number of the plurality of second fingers is less than the number of the plurality of first fingers.

17. The display apparatus according to claim 10, wherein a spacing between adjacent second fingers is greater than a spacing between adjacent first fingers.

18. The display apparatus according to claim 10, wherein ends of the plurality of second fingers are not connected to each other.

19. The display apparatus according to claim 10, wherein the plurality of second fingers have a structure configured to be bent in a certain direction at a central portion of each thereof.

20. The display apparatus according to claim 10, wherein the thin film transistor comprises a gate electrode, a semiconductor pattern, a drain electrode, a source electrode, a gate insulating film disposed between the gate electrode and the semiconductor pattern, and an element protection film configured to cover the semiconductor pattern, the drain electrode, and the source electrode; and
wherein the gate insulating film and the element protection film are not disposed below the pixel electrode in each of the subpixel areas in the sensing area.
